(19) United States
(12) Patent Application Publication
(10) Pub. No.: US 2005/0015716 A1
(43) Pub. Date: Jan. 20, 2005

(54) Financial document change identifier

(76) Inventors: Andre Lavoie, Boston, MA (US); Suriyan Lohavichan, Arlington, MA (US); Roland C. Beaulieu, Littleton, MA (US)

Correspondence Address: ST. ONGE STEWARD JOHNSTON & REENS, LLC, 986 BEDFORD STREET, STAMFORD, CT, 06905-5619, US

(21) Appl. No.: 10/822,310

(22) Filed: Apr. 12, 2004

Related U.S. Application Data
(60) Provisional application No. 60/462,065, filed on Apr. 11, 2003.
(60) Provisional application No. 60/461,386, filed on Apr. 10, 2003.

(51) Int. Cl. G06F 17/00

(52) U.S. Cl. 715/511

(57) ABSTRACT

An apparatus for generating a comparison of related subject matter found in two different financial documents. The apparatus includes a first document with at least a portion of said first document in a tabular data format, a second document with at least a portion of said second document in a tabular data format, said second document being a variation of said first document, a processor for receiving said first document and said second document and a comparator executing on said processor for comparing said first document tabular data to related subject matter of said second document tabular data to generate tabular delta data indicative of at least one of change and percentage change between the related subject matter of said first document tabular data and said second document tabular data.

### PRIOR APPLICATION

Applicant claims priority benefits under 35 U.S.C. §119(e) of U.S. Provisional Patent Application Ser. No. 60/462,065, filed Apr. 11, 2003, and U.S. Provisional Patent Application Ser. No. 60/461,386, filed May 16, 2003.

### FIELD OF THE INVENTION

The present invention provides a method and system for comparing the data of a document with related subject matter data of a variation of the document, to identify and/or quantify the relationship between the document data and related subject matter in the variation document data.

### BACKGROUND OF THE INVENTION

A prime commodity of the information society in which we live is timely, cost effective, and accurate data analysis. However, research is currently produced in prodigious quantities in almost all fields of study, including but not limited to, finance, medicine, engineering, social sciences, and government. As such, the goal of timely, cost effective, and accurate data analysis is becoming persistently more difficult to achieve due to an analyst's limited resources to study all the available research data.

A principal reason for the flood of research information is the efficiency enabled by modern data processing tools such as word processing and spreadsheet programs, which allow a researcher to generate a highly detailed report in a matter of hours or days when it used to take days or weeks to produce the same report without modern data processing tools. Also, since data produced for prior reports is presently so easy to manipulate, research reports have been expanding in size because a current research report is generally an updated version of an older research report. As a result, large quantities of research data are generated that can obscure the data that is relevant to an analyst's particular research goal.

For example, publicly traded companies are required to file an annual report (“10-K”) with the Securities and Exchange Commission (“SEC”) that is a comprehensive summary of the company's performance for a given year and the financial analyst that follows the company usually does not want to wade through every detail of a lengthy 10-K every year to discern what the current 10-K states because a portion of the data is a repeated version of what the analyst had researched last year. Instead, most analysts want to know where the additions, deletions, substitutions, and changes are located in the new and old documents and what is the numerical difference between a prior document value when compared to a present document value.

Further, publicly traded companies also have to submit to the SEC a quarterly report (“10-Q”) that details their financial position over the last quarter and/or publicly disseminate relevant information to the public at other prescribed times in order to comply with various governmental regulations. As such, most of the documents produced are variations of previously produced documents and therefore the changes and/or differences between a document and its variation is the information that many researchers are seeking.

Consequently, what is need is a system and method that will reduce the research work load by identifying and/or quantifying data indicative of relationships such as additions, deletions, substitutions, changes, and percentage changes that occur when subject matter of a document is compared to related subject matter of a variation of the document.

### SUMMARY OF THE INVENTION

Accordingly, it is an object of the present invention to provide systems and methods that can identify and/or quantify comparison data indicative of relationships such as additions, deletions, substitutions, changes, and percentage changes produced by comparing data of a document with related subject matter data from and a variation of that document.

Another object of the present invention is to provide a system and method to show where the additions, deletions, substitutions, change and/or the percentage change of comparison data between two documents occurs. This will permit an analyst to focus their efforts on determining the impact of such changes rather than spending their time trying to locate the changes.

A further object of the present invention is to provide a system and method that can compare specific quantities of a first table with counterpart specific quantities of a second table and then calculate the change, degree of change, and/or percentage change in a specific quantity and to display such results in numeric and graphic formats.

Still another object of the present invention is to provide a system and method for a web-based interface to distribute a report containing data indicative of relationships such as additions, deletions, substitutions, change, degree of change, and/or percentage change produced by the comparison of related subject matter data contained in two different documents.

And yet still another object of the present invention is to provide a system and method to separate textual data from tabular data in a document containing textual and tabular data.

Still yet another object of the present invention is to provide users an interface to access a document that is produced by a comparison of a government filing document that is compared with related subject matter in a variation of the government filing document.

And still yet another object of the present invention is to provide a system and method to integrate text and tabular data that had been previously separated into a single report.

Yet still another object of the present invention is to provide a system and method that can compare tabular data from a document with related subject matter tabular data of a variation of the document to generate the change, degree of change, and/or percentage change between the related subject matter in the two documents.

These and other objects of the present invention are achieved by providing an apparatus for generating a comparison of related subject matter found in two different financial documents, the apparatus including a first document with at least a portion of said first document in a tabular data format, a second document with at least a portion of said second document in a tabular data format, said second document being a variation of said first document, a processor for receiving said first document and said second document and a comparator executing on said processor for comparing said first document tabular data to related subject matter of said second document tabular data to generate tabular delta data indicative of at least one of change and percentage change between the related subject matter of said first document tabular data and said second document tabular data.

An alternative embodiment of the present invention would further comprise a user interface in communication with said processor for delivering at least one of said tabular data and tabular delta data wherein said tabular delta data is delivered on said user interface as visually distinct from said tabular data, wherein said visually distinct tabular delta data for the change between said first document tabular data and said second document tabular data is represented in a first manner and the percentage change between said first document tabular data and said second document tabular data is represented in a second manner, wherein there is a plurality of said visually distinct tabular delta data, wherein said tabular delta data delivered on said user interface is chronicled by at least one of numeric, alphabetic, alphanumeric, and consecutive sequence units, wherein said comparator inserts into said tabular delta data a graphic indicative of change magnitude for each change and percentage change between related subject matter of said first document tabular data and said second document tabular data, wherein said graphic is comprised of at least one of graphs, charts, statistics, and images, and wherein said comparator compares sections of said first document tabular data with related subject matter sections of said second document tabular data based on at least one of tables, graphs, columns, rows, time units, idea units, and line items.

Another embodiment of the present invention would further comprise said first document tabular data and said second document tabular data both contain data in a text format and said comparator compares said first document text/tabular data to related subject matter of said second document text/tabular data to generate text/tabular delta data, wherein said text/tabular delta data includes at least one of additions data, deletions data, and substitutions data, a user interface in communication with said processor for delivering at least one of said additions data, deletions data, substitutions data, and text/tabular data, wherein said additions data, deletions data, and substitutions data is each delivered on said user interface as visually distinct from said text/tabular data, wherein said visually distinct additions data is represented in a third manner, deletions data is represented in a fourth manner, and substitutions data is represented in a fifth manner, wherein said additions data, deletions data, and substitutions data are chronicled on said user interface by at least one of numeric, alphabetic, alphanumeric, and consecutive sequence units, wherein said comparator compares sections of said first document text/tabular data with related subject matter sections of said second document text/tabular data based on at least one of words, sentences, paragraphs, pages, columns, rows, headers, idea units, and line items, and wherein said comparator integrates at least two of said tabular delta data, text/tabular delta data, tabular data, and text/tabular data for delivery on said user interface.

And still yet another embodiment of the present invention would further comprise said first document and said second document further comprises data in a text format and said comparator separates said text from said tabular data in said first document and said second document prior to comparison of said first document to said second document, wherein said comparator compares said first document text to related subject matter of said second document text to generate text delta data, wherein said text delta data includes at least one of additions data, deletions data, and substitutions data, a user interface in communication with said processor for delivering at least one of said additions data, deletions data, substitutions data, and text, wherein said additions data, deletions data, and substitutions data is each delivered on said user interface as visually distinct from said text, wherein said visually distinct additions data is represented in a third manner, deletions data is represented in a fourth manner, and substitutions data is represented in a fifth manner, wherein said additions data, deletions data, and substitutions data are chronicled on said user interface by at least one of numeric, alphabetic, alphanumeric, and consecutive sequence units, wherein said comparator compares sections of said first document text with sections related subject matter of said second document text based on at least one of words, sentences, paragraphs, pages, columns, rows, headers, idea units, and line items, wherein said comparator integrates at least two of said tabular delta data, text delta data, tabular data, and text for delivery on said user interface, and wherein said comparator also integrates in at least one of text/tabular data and text/tabular delta data for delivery on said user interface.

Still yet another embodiment of the present invention is a system for generating a comparison of related subject matter found in two different financial documents, the system including a first document with at least a portion of said first document in a tabular data format, a second document with at least a portion of said second document in a tabular data format, said second document being a variation of said first document, and a processor for receiving said first document and said second document and computer executable instructions executing on said processor for comparing said first document tabular data to related subject matter of said second document tabular data to generate tabular delta data indicative of at least one of change and percentage change between the related subject matter of said first document tabular data and said second document tabular data.

Yet another embodiment of the present invention is a method for generating a comparison of related subject matter found in two different financial documents, the method including providing a first document with at least a portion of said first document in a tabular data format, providing a second document with at least a portion of said second document in a tabular data format, said second document being a variation of said first document, receiving said first document and said second document into a processor, and comparing in said processor said first document tabular data to related subject matter of said second document tabular data to generate tabular delta data indicative of at least one of change and percentage change between the related subject matter of said first document tabular data and said second document tabular data.

Other objects, features and advantages according to the present invention will become apparent from the following detailed description of certain advantageous embodiments when read in conjunction with the accompanying drawings in which the same components are identified by the same reference numerals.

### BRIEF DESCRIPTION OF THE DRAWINGS

FIG. 1 is an exemplary block diagram illustrating an apparatus for identifying and/or quantifying data indicative of relationships such as additions, deletions, substitutions, changes, and percentage changes produced by comparing a document and related subject matter in variation of the document in accordance with the principals of the present invention;

FIG. 2 is an exemplary flowchart illustrating a process for identifying and/or quantifying data indicative of relationships such as additions, deletions, substitutions, changes, and percentage changes produced by comparing a document and related subject matter in variation of the document in accordance with the principals of the present invention of FIG. 1;

FIG. 3 is an exemplary flowchart illustrating a process for identifying and/or quantifying data indicative of relationships such as additions, deletions, substitutions, changes, and percentage changes produced by comparing a document and related subject matter in variation of the document in accordance with the principals of the present invention of FIG. 1;

FIG. 4 is an exemplary table of data set matching according to the principals of the present invention of FIG. 1;

FIG. 5 is an example of a textual comparison of related subject matter from two different documents according to the principals of the present invention of FIG. 1;

FIG. 6 is an example of the insertion of graphics into a comparison document according to the principals of the present invention of FIG. 1;

FIG. 7 is an example of a comparison of related tabular data subject matter from two different documents according to the principals of the present invention of FIG. 1;

FIG. 8 is an example of the insertion of graphics into a comparison document according to the principals of the present invention of FIG. 1; and

FIG. 9 is an example of a comparison of text/tabular data and tabular data according to the principals of the present invention of FIG. 1.

### DETAILED DESCRIPTION OF CERTAIN ADVANTAGEOUS EMBODIMENTS

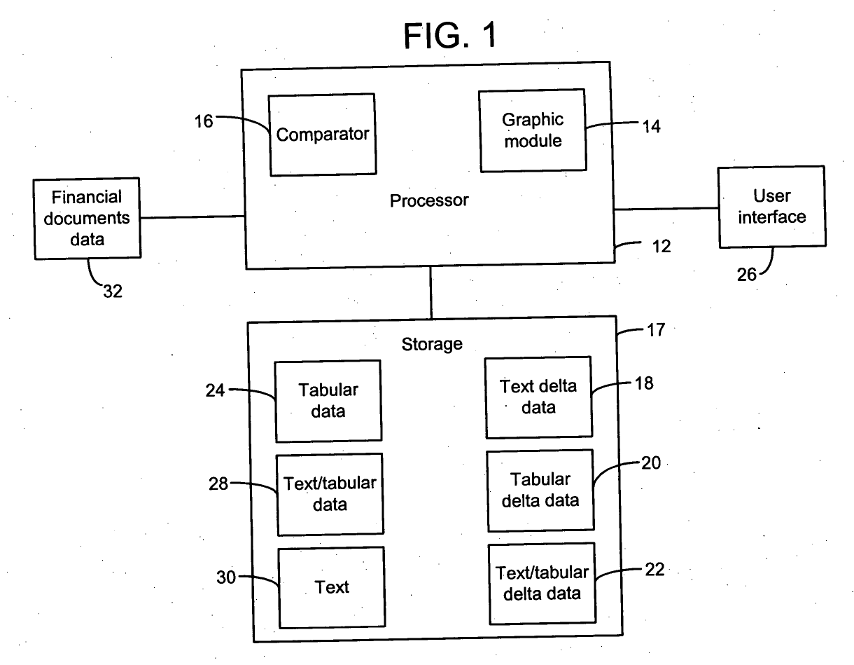

Referring now to the drawings, wherein like reference numerals designate corresponding structure throughout the views. FIG. 1 is an exemplary block diagram illustrating a system 10 for identifying and/or quantifying data indicative of relationships such as additions, deletions, substitutions, changes, and/or percentage change produced by comparing a document to a variation of the document. System 10 includes at least one processor 12 having executing thereon comparator 16 and graphic module 14 and comparator 16 and graphic module 14 can both be realized in hardware and/or software.

Processor 12 is a data processing device that can be implemented in hardware and/or software such as a computer, personal digital assistant, cell phone, organizer, web enabled television, and the like. User interface 26 is in communication with processor 12 to receive data generated by processor 12 as well as to transmit data into processor 12.

In one embodiment, user interface 26 can be a remote access node such as a web browser executing on a remote computer and communicating with processor 12 over a global communications network such as the Internet. In an alternative embodiment, user interface 26 can be a local access node such as a computer communicating with processor 12 over a communications network such as an intranet. In yet another embodiment, user interface 26 can utilize a combination of the preceding communications networks.

System 10 also includes at least one storage 17 that provides primary and/or secondary storage. Storage 17 is in communication with processor 12 and can store thereon tabular data 24, text/tabular data 28, text 30, text delta data 18, tabular delta data 20, text/tabular data 22, and financial document data 32. Processor 12 can receive financial document data 32 such as a 10-K, 10-Q, earnings forecast, and the like of a particular company and financial document data 32 can include multiple versions of the same document. In an alternative embodiment, financial document data 32 can be comprised of a portion, or portions, of a complete financial document and/or documents.

In one embodiment, financial document data 32 received by processor 12 includes at least two documents and one of the documents is a variation of the other document. For instance, financial document data 32 can be a present year 10-K of a particular company as well as the preceding year 10-K document of the same company. Because the 10-K are from different years, the two documents have at least some differences thereby making one 10-K a variation of the other 10-K. In an alternative embodiment, financial document data 32 includes only one document and a second document, which is a variation of the received document, is retrieved from storage 17.

The data format of financial document data 32 can vary and the format includes types such as tabular data 24, text/tabular data 28, and text 30. Tabular data 24 can be data such as tables, graphs, charts, numeric, and the like, text/tabular data 28 can be textual data found within the tables, graphs, charts, numeric, and the like of tabular data 24, and text 30 can be substantially comprised of textual data.

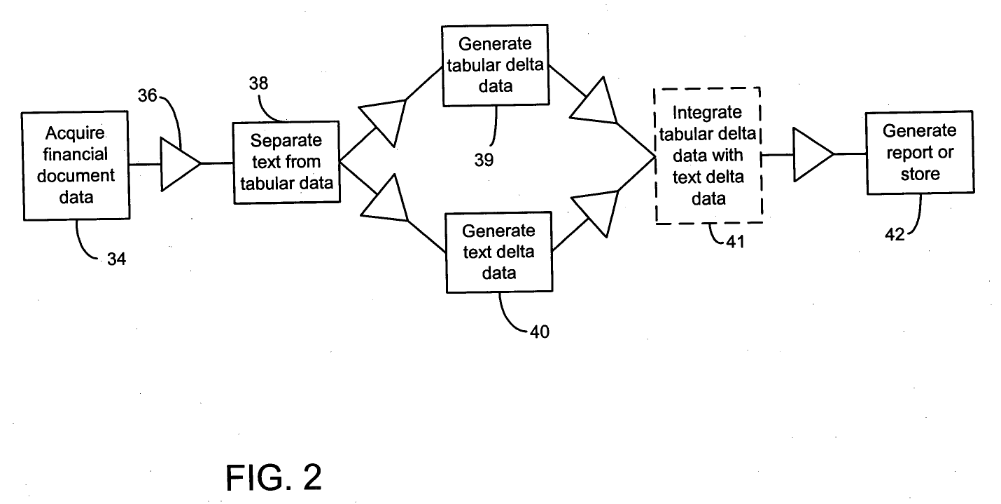

Financial document data 32 being compared by system 10 can be unstructured text documents such as SEC filings in which tables often appear in the document as inline text. Referring now to FIG. 2, in one embodiment of the invention, only tabular data 24 is present in data flow 36 and in an alternative embodiment of the invention, only text 30 is in data flow 36. In the preferred embodiment of the invention, both tabular data 24 and text 30 is present in data flow 36.

When both tabular data 24 and text 30 are present in financial document data 32, comparator 16 will separate tabular data 24 from text 30 to facilitate the comparison process, at block 38. In this case, tabular data 24 from a document is compared to related subject matter from a variation of the document and text 30 from the document is compared to related subject matter text 30 from the variation. The comparator 16 operates on the related subject matter between the two documents to generate tabular delta data 20 at block 39 for the compared tabular data 24 and text delta data 18 for the compared text 30 at block 40.

In one embodiment, comparator 16 can perform the optional step of integrating tabular delta data 20 and text delta data 18 into a single document that is substantially similar in data layout to the underlying financial document data 32 layout at block 41. The optional nature of block 41 is illustrated with dotted lines in FIG. 2 to signify that it is an optional step. The integrated document can then be available for delivery to user interface 26 and/or sent to storage 17 for later access at block 42.

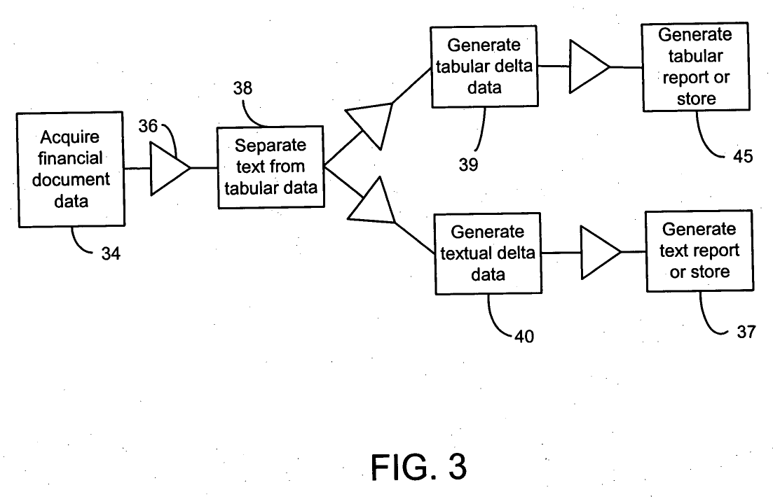

In an alternative embodiment as shown in FIG. 3, tabular delta data 20 and text delta data 18 are not integrated into a single document. As such, a report can be generated for tabular delta data 20, which can then be available for delivery to user interface 26 and/or sent to storage 17 for later access at block 45. Also, a report can be generated for text delta data 18, which can then be available for delivery to user interface 26 and/or sent to storage 17 for later access at block 37.

In one embodiment, system 10 utilizes a common information format system such as SGML, XML, XSL, HTML, dynamic HTML, XHTML, XLink, and the like. The common information format system provides tags in the data for providing formatting commands, data descriptions, and the like. Data such as financial document data 32, tabular data 24, text/tabular data 28, text 30, text delta data 18, tabular delta data 20, and text/tabular delta data 22 contain tags with information including, but not limited to, as data type, location data, ideas units, time units, numerical units, and currency units.

An example of a data type rule that can be included in the tag of a portion of financial document data 32 is the identification of data as tabular data 24 or text 30. Such a tag facilitates the separation of tabular data 24 from text 30 by comparator 16 at block 38. Another example of a data type rule that can be included in a tag in a portion of tabular data 24 is one that can be used to identify the data as types such as percentage, currency, numeric, time units, units of measure, and/or the like thereby assisting comparator 16 in making comparison of like quantities.

For instance, if the values of the table are not in whole units, the tag can designate the units as such, e.g. hundreds, thousands, millions, billions, and the like. This identification can vary and examples are:
000's omitted
In thousands except per-share amounts
Millions, except share data
In millions
In millions, except share data
Expressed in thousands
Thousands of dollars
($000's)

To compute the comparison correctly for two sets of tabular data 24, comparator 16 would identify the type of data in each cell and identifies it as percent, text, numeric or currency. For example, it is important that comparator 16 know what currency is associated with values within the table to prevent incorrect comparison computations due to a shift in currency denomination. To prevent this problem, comparator 16 utilizes a standard set of world currencies.

In one embodiment, the tags can also be used to divide tabular data 24 into different types of table categories such as tables that represent a period of time, tables that represent a point in time, and/or a generic bucket to hold the remaining tables. For example, an income statement and statement of cash flows would represent a table holding data representative of a period of time while a balance sheet is representative of a table that represents a point in time data.

An example of an idea unit is where multiple lines of textual data comprise a single concept in a section of text 30 or where multiple rows and/or line items represent a single concept in a section of tabular data 24. Similarly, idea units can be used during the comparison operation to separate multiple ideas in a single portion of a document such as when a single line of text 30 is composed of two discrete concepts as can happen in a compound sentence in a transcript of an earnings call. Idea units can be utilized by comparator 16 to determine what portions of a variation document are related subject matter of the document in financial document data 32.

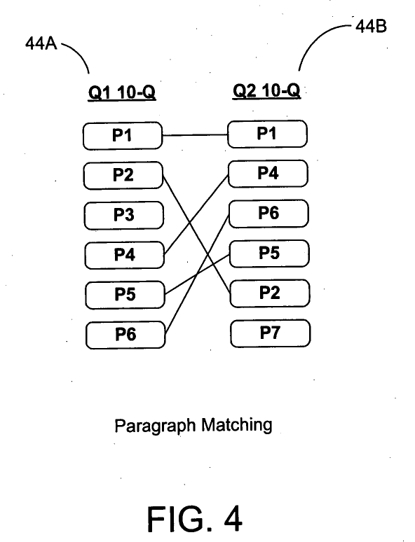

An example of location data is the location identification of a particular portion of financial document data 32 within a given document and/or section of a document. For example, location data such as section, page, section of page, and the like enables comparator 16 to keep track of a particular portion, or portions, of financial document data 32. Location data can also be used to identify a section, or sections, that do not need to be compared such as the Table of Contents section of a document. Also, location data is utilized by comparator 16 in conjunction with idea units to determine what portions of financial document data 32 are related subject matter to portions of the variation document, e.g. the subject matter of FIG. 4.

For example, comparator 16 should not mark a portion of tabular data 24 as a deletion or addition if such data merely has a different location in the variation document. Instead, comparator 16 should match document tabular data 24 with corresponding related subject matter in the variation document and then compare the data appropriately because the relocation was not an addition/deletion.

FIG. 4 is an example of how different tags can be utilized by system 10 to match a data set from a document to a data set in a variation of the document. Document 44A is a first quarter report (“Q1 10-Q”) of a particular company. Document 44B is a second quarter report (“Q2 10-Q”) of the same particular company that produced document 44A and therefore document 44B is a variation of document 44A. As such, document 44A can have portions that share the same and/or related subject matter with portions of document 44B such as paragraphs P1.

Paragraph P1 in document 44A is represented as having the same location data as well as similar idea units as P1 of document 44B. The subject matter of P1 in document 44A can be compared to related subject matter in P1 of document 44B.

Similarly, P2 in document 44A is represented as sharing similar ideas units with P2 of document 44B but the P2 of document 44B does not share similar location data with the P2 of document 44A. The subject matter of P2 in document 44A can be compared to related subject matter in P2 of document 44B.

Further, P3 of document 44A does not match any paragraph in document 44B and P7 of document 44B does not match any paragraph in document 44A. This represents that P3 and P7 can be additions data, deletions data or substitutions data.

In this example, because the information of document 44A was produced before the information of document 44B, P3 represents deletions data because it is data found in document 44A but not in document 44B and therefore P3 was not included in document 44B. As a result, comparator 16 can represent P3 as deletions data.

Further, P7 represents additions data because it is data found in document 44B but not in document 44A. Consequently, comparator 16 can represent P7 as additions data. Substitutions data would be data in one document that is similar in concept to data in the other document but is not substantially identical.

The preceding example used paragraphs but system 10 utilizes similar techniques for matching and determining additions data, deletions data or substitutions data for document structures such as tables, graphs, charts, rows, columns, row identifiers, column identifiers, sentences, and the like. Also, system 10 treats text/tabular data 28 in a manner similar to text 30.

In one embodiment, location data can be utilized by comparator 16 to facilitate the integration of different portions of the compared documents back into a version that is substantially similar in organizational layout to one of the documents that comprised financial document data 32. In an alternative embodiment, location data can be utilized by comparator 16 to facilitate the integration of different portions of the compared documents back into a version that is substantially similar in organizational layout to each documents original organizational layout.

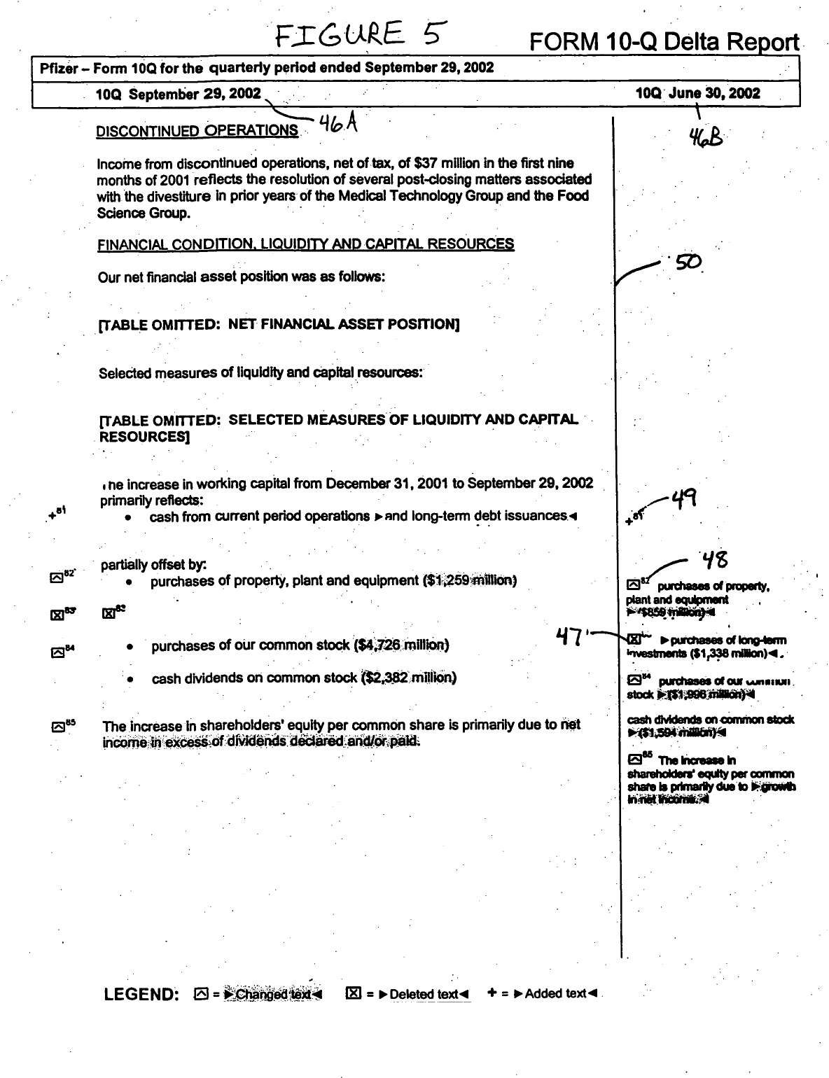

An example of a text 30 comparison between two documents is illustrated in FIG. 5 in which document 46A has been compared to document 46B. In one embodiment, the comparison results are provided in side-by-side presentation that is separated by divider 50. One side of divider 50 can be the most current version of the compared document set and can be shown in its entity while the older version of the document can show the deletions data 47, and substitutions data 48. Additions data 49 is generally shown in the most current document although a chronicle unit 49 for the additions data can appear on the older version side. One advantage the side-by-side report is that the identified changes data is very easy to comprehend because the most recent document is presented substantially in its entirety and with minimal impact from the identified deletions data and substitutions data.

In an alternative embodiment, the entirety of both compared documents can be presented on user interface 26 and/or in a report. In yet another embodiment, the arrangement of the two data sets produced by the comparison can be presented as a single document and in a single field. In still yet another embodiment, the two data sets produced by the comparison of system 10 can be presented in a split field format with the data set from one document in one field that is separate and below the data set from the other document.

In one embodiment, additions data, deletions data, and substitutions data can each be presented as visually distinct from each other and from the original text. In other words, original text can be presented in a first manner, additions data can be presented in second manner, deletions data can be presented in a third manner, and substitutions data can be presented in a fourth manner. For instance, the first manner can be one color, the second manner can be a second color, the third manner can be a third color, and the fourth manner can be fourth color. Also, additions data, deletions data, and substitutions data can be chronicled by a sequential notation system such as numeric, alphabetic, alphanumeric, consecutive sequence units and the like.

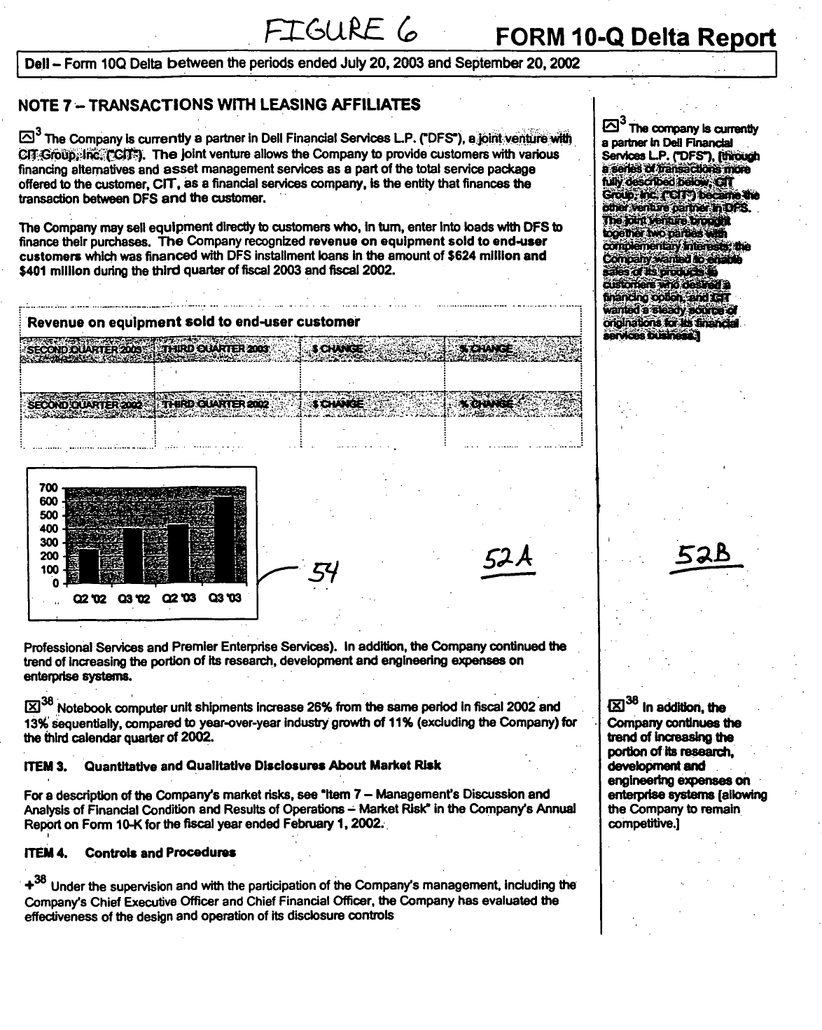

FIG. 6 illustrates an example of how graphic module 14 inserts graphic 54 into document 52A. Graphic 54 is a bar graph that can represent the compared concepts presented in the preceding paragraph. Graphic module 14 can insert graphics such as graphs, charts, statistics, images, and the like into a compared document thereby quantifying for a user the results of two compared concepts or idea units.

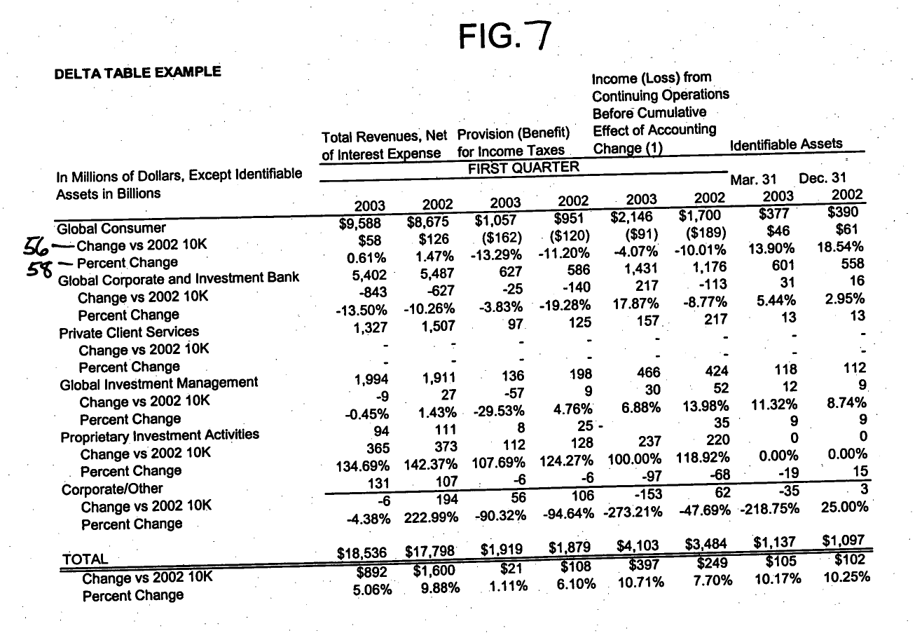

FIG. 7 is an example of the comparison operation performed on a 2002 10-K and a 2003 10-K from the same company by system 10. Comparator 16 calculates the changes data in row 56 by determining the difference between the current filing value and the previous filing value for each matched data pair for a given pair of 10-K documents. A matched data pair can be the grouping of a particular set of related subject matter that is in two different documents and the related subject matter is converted to be in the same units. In this example the matched data pairs are line items from a 2002 10-K and a 2003 10-K for the same company.

In row 58 percent changes data can be calculated by dividing the current filing value by the previous filing value, minus one, times 100 for each matched data pair of related subject matter. Before percentage changes data is computed, the matched data pair should be converted to use the same units.

In one embodiment, when calculating changes data and percentage changes data, if a data value in one document does not match a related subject matter data value in the other document, +100% or −100% can be inserted as a placeholder and the sign can be determined by the sign of the current filing value.

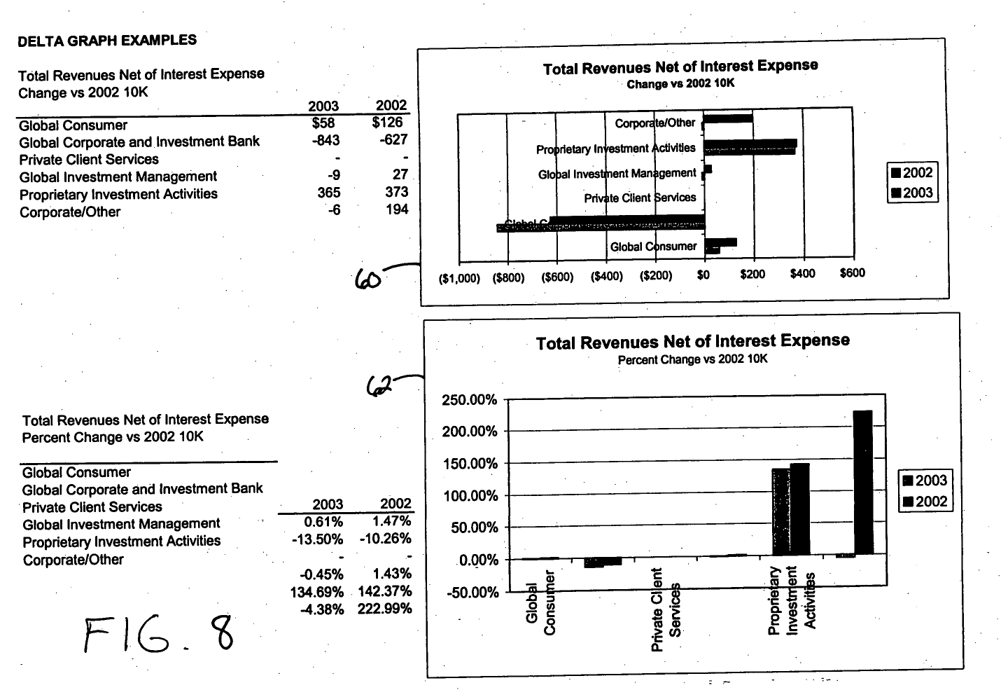

FIG. 8 illustrates examples of graphics such as chart 60 that can be inserted into tabular data 24 by graphic module 14. Chart 60 shows the change from a 2003 10-K to a 2002 10-K and chart 62 shows the percentage change from the 2003 10-K to the 2002 10-K.

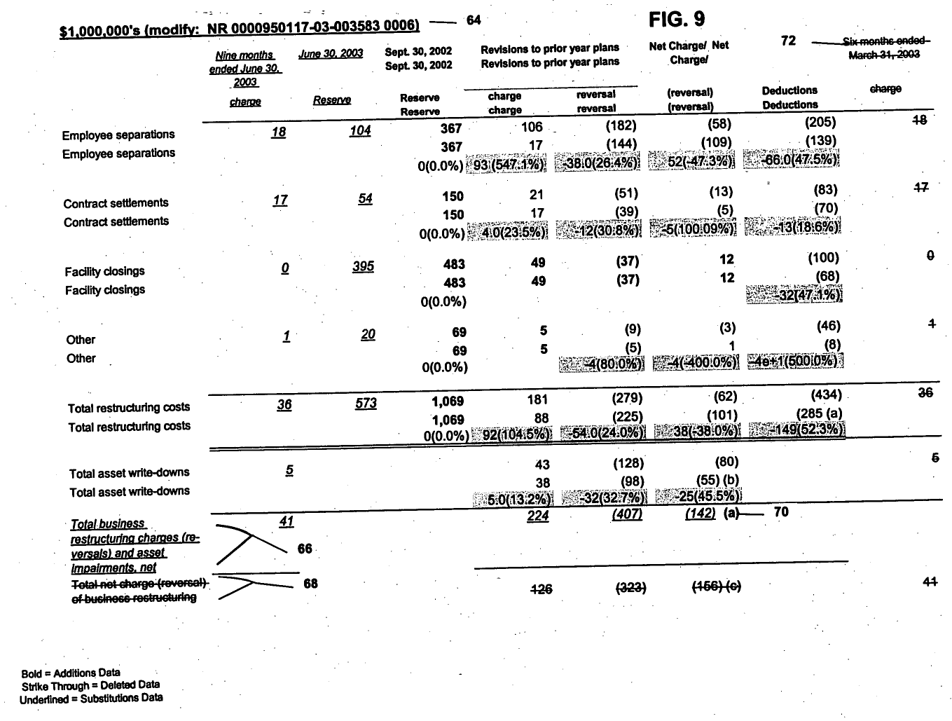

FIG. 9 illustrates a number of examples of additions data, deletions data, substitutions data, changes data, and percentage changes data in a portion of tabular data 28. Row label 66 is substitutions data that serves to identify the data content of a given row. In one embodiment, deletions data is positioned near the substitutions data as is exemplified by strikethrough row label 68 because the idea unit difference between the substitutions data and the deleted data may be slight. As such, the inclusion of both the substitution data and the deletions data enables a user to compare the wording differences between the two and to draw their own conclusions.

Footnote 70 is additions data that indicates that a footnote has been added for a particular line item. Column 72 illustrates how an entire column of data can be indicated as deletions data. Also, table header 64 identifies the table and its location to facilitate the integration of the table into a document that can have a data layout that is similar to one of the documents that was utilized by system 10 for the comparison operation.

Other objects, features and advantages according to the present invention will become apparent from the following detailed description of certain advantageous embodiments when read in conjunction with the accompanying drawings in which the same components are identified by the same reference numerals.

1. An apparatus for generating a comparison of related subject matter found in two different financial documents, the apparatus comprising:
a first document with at least a portion of said first document in a tabular data format;
a second document with at least a portion of said second document in a tabular data format, said second document being a variation of said first document;
a processor for receiving said first document and said second document; and
a comparator executing on said processor for comparing said first document tabular data to related subject matter of said second document tabular data to generate tabular delta data indicative of at least one of change and percentage change between the related subject matter of said first document tabular data and said second document tabular data.

2. The apparatus of claim 1 further comprising a user interface in communication with said processor for delivering at least one of said tabular data and tabular delta data.

3. The apparatus of claim 2 wherein said tabular delta data is delivered on said user interface as visually distinct from said tabular data.

4. The apparatus of claim 3 wherein said visually distinct tabular delta data for the change between said first document tabular data and said second document tabular data is represented in a first manner and the percentage change between said first document tabular data and said second document tabular data is represented in a second manner.

5. The apparatus of claim 4 wherein there is a plurality of said visually distinct tabular delta data.

6. The apparatus of claim 5 wherein said tabular delta data delivered on said user interface is chronicled by at least one of numeric, alphabetic, alphanumeric, and consecutive sequence units.

7. The apparatus of claim 2 wherein said comparator inserts into said tabular delta data a graphic indicative of change magnitude for each change and percentage change between related subject matter of said first document tabular data and said second document tabular data.

8. The apparatus of claim 7 wherein said graphic is comprised of at least one of graphs, charts, statistics, and images.

9. The apparatus of claim 1 wherein said comparator compares sections of said first document tabular data with related subject matter sections of said second document tabular data based on at least one of tables, graphs, columns, rows, time units, idea units, and line items.

10. The apparatus of claim 1 wherein said first document tabular data and said second document tabular data both contain data in a text format and said comparator compares said first document text/tabular data to related subject matter of said second document text/tabular data to generate text/tabular delta data.

11. The apparatus of claim 10 wherein said text/tabular delta data includes at least one of additions data, deletions data, and substitutions data.

12. The apparatus of claim 11 further comprising a user interface in communication with said processor for delivering at least one of said additions data, deletions data, substitutions data, and text/tabular data.

13. The apparatus of claim 12 wherein said additions data, deletions data, and substitutions data is each delivered on said user interface as visually distinct from said text/tabular data.

14. The apparatus of claim 13 wherein said visually distinct additions data is represented in a third manner, deletions data is represented in a fourth manner, and substitutions data is represented in a fifth manner.

15. The apparatus of claim 11 wherein said additions data, deletions data, and substitutions data are chronicled on said user interface by at least one of numeric, alphabetic, alphanumeric, and consecutive sequence units.

16. The apparatus of claim 10 wherein said comparator compares sections of said first document text/tabular data with related subject matter sections of said second document text/tabular data based on at least one of words, sentences, paragraphs, pages, columns, rows, headers, idea units, and line items.

17. The apparatus of claim 12 wherein said comparator integrates at least two of said tabular delta data, text/tabular delta data, tabular data, and text/tabular data for delivery on said user interface.

18. The apparatus of claim 1 wherein said first document and said second document further comprises data in a text format and said comparator separates said text from said tabular data in said first document and said second document prior to comparison of said first document to said second document.

19. The apparatus of claim 18 wherein said comparator compares said first document text to related subject matter of said second document text to generate text delta data.

20. The apparatus of claim 19 wherein said text delta data includes at least one of additions data, deletions data, and substitutions data.

21. The apparatus of claim 20 further comprising a user interface in communication with said processor for delivering at least one of said additions data, deletions data, substitutions data, and text.

22. The apparatus of claim 21 wherein said additions data, deletions data, and substitutions data is each delivered on said user interface as visually distinct from said text.

23. The apparatus of claim 22 wherein said visually distinct additions data is represented in a third manner, deletions data is represented in a fourth manner, and substitutions data is represented in a fifth manner.

24. The apparatus of claim 20 wherein said additions data, deletions data, and substitutions data are chronicled on said user interface by at least one of numeric, alphabetic, alphanumeric, and consecutive sequence units.

25. The apparatus of claim 18 wherein said comparator compares sections of said first document text with sections related subject matter of said second document text based on at least one of words, sentences, paragraphs, pages, columns, rows, headers, idea units, and line items.

26. The apparatus of claim 18 wherein said comparator integrates at least two of said tabular delta data, text delta data, tabular data, and text for delivery on said user interface.

27. The apparatus of claim 26 wherein said comparator also integrates in at least one of text/tabular data and text/tabular delta data for delivery on said user interface.

28. A system for generating a comparison of related subject matter found in two different financial documents, the system comprising:
a first document with at least a portion of said first document in a tabular data format;
a second document with at least a portion of said second document in a tabular data format, said second document being a variation of said first document; and
a processor for receiving said first document and said second document and computer executable instructions executing on said processor for comparing said first document tabular data to related subject matter of said second document tabular data to generate tabular delta data indicative of at least one of change and percentage change between the related subject matter of said first document tabular data and said second document tabular data.

29. A method for generating a comparison of related subject matter found in two different financial documents, the method comprising:
providing a first document with at least a portion of said first document in a tabular data format;
providing a second document with at least a portion of said second document in a tabular data format, said second document being a variation of said first document;
receiving said first document and said second document into a processor; and
comparing in said processor said first document tabular data to related subject matter of said second document tabular data to generate tabular delta data indicative of at least one of change and percentage change between the related subject matter of said first document tabular data and said second document tabular data.
